(19) United States
(12) Patent Application Publication
(10) Pub. No.: US 2016/0357858 A1
(43) Pub. Date: Dec. 8, 2016

(54) USING ONLINE SOCIAL NETWORKS TO FIND TRENDS OF TOP VACATION DESTINATIONS

(71) Applicant: Umm Al-Qura University, Makkah (SA)

(72) Inventors: Sohaib GHANI, Makkah (SA); Mohamed MOKBEL, Makkah (SA); Jalal ALOWIBDI, Makkah (SA)

(73) Assignee: Umm Al-Qura University, Makkah (SA)

(21) Appl. No.: 14/731,076

(22) Filed: Jun. 4, 2015

(51) Int. Cl. G06F 17/30

(52) U.S. Cl. CPC G06F 17/30696; G06F 17/30699; G06F 17/30061

(57) ABSTRACT

A system, method, and apparatus for destination trend determination is provided. The method includes receiving a user query, accessing a database, the database including spatiotemporal content from a plurality of users, generating a first dataset by filtering the database according to the user query, generating a second dataset by filtering the database according to the user query, comparing the first dataset and the second dataset to determine one or more unique users associated with spatiotemporal content in both the first dataset and the second dataset, analyzing the spatiotemporal content of the one or more unique users to determine one or more locations of the spatiotemporal content corresponding to the second dataset, and controlling a display of the analyzed content.

### BACKGROUND

The description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The task of choosing a location for vacations, trips, and weekend getaways is often confusing and time consuming. Travel planners often find themselves with two options for vacation planning: paying for the expertise of a travel agent, or performing research on their own by consulting websites, magazine, friends, family, and the like. However, even if the planner eventually decides on a travel destination after much research, the planner is often unsure whether the travel destination is a preferred choice. Information that the planner obtains on their own or from travel agents may be outdated, biased, or inappropriate for the planner's particular circumstances. Unless the planner is provided with as much information as possible, the decided travel destination may turn out to be a failure.

### SUMMARY

In recent years, the proliferation of internet usage by persons of all ages all over the globe, especially in the form of mobile computing, has created a virtually unending flood of information. Popular online information hubs and social networks providing microblogging platforms (such as Twitter), social networking services (such as Facebook), and media sharing services (such as Flickr) generate billions of publicly available information data points daily. This data is gathered, filtered, and analysed to solve the above-mentioned problems faced by travel planners by, for example, finding trends in vacation destinations based on actual visitors and their experiences.

Online social networks such as Twitter, Facebook, and Flickr are becoming very popular and more sophisticated as technology improves. The content generated on the online social networks often includes at least a date/time and a location (geolocation) accompanying the content itself. Analysis of the timed and geotagged social networking content (e.g., tweets, posts, photos, comments) is useful in determining trends in top vacation destinations.

In a preferred embodiment, indexing, spatiotemporal querying, and machine learning techniques are used to check, analyze, and filter user activities in a particular region before and/or during a specific time period, such as a holiday. The results are visualized and recommendations of top vacation destinations for the specific time period are given.

Accordingly, a location-based application is provided that checks geotagged data before and/or during any specific time period and analyzes it to find trends of top vacation destinations visited by others to help people decide where they should spend their holidays, weekends, and other free time.

Moreover, the techniques disclosed herein are not only applicable to travel planners planning their next vacation or weekend destination, but also to other real world problems. For example, governmental agencies require information to promote tourism in their countries, and entities in law enforcement, advertising and media, and businesses such as restaurants and shopping stores need to learn about where to focus their attention during particular holidays.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

The disclosure will be better understood from reading the description which follows and from examining the accompanying figures. These are provided solely as non-limiting examples of embodiments. In the drawings:

FIG. 1 illustrates a flow of data analysis in the destination trend determination method according to an embodiment;

FIG. 2 illustrates a visualization of a result of the destination trend determination method according to an embodiment; and

FIG. 3 illustrates an exemplary device used in conjunction with the destination trend determination method according to an embodiment.

### DETAILED DESCRIPTION

The description provided here is intended to enable any person skilled in the art to understand, make and use this invention. Various modifications to the disclosed embodiments will be readily apparent to those skilled in the art, and the general principals defined herein may be applied to these modified embodiments and applications without departing from the scope of this invention. In each of the embodiments, the various actions could be performed by program instruction running on one or more processors, by specialized circuitry or by a combination of both. Moreover, the invention can additionally be considered to be embodied, entirely or partially, within any form of computer readable carrier containing instructions that will cause the executing device to carry out the technique disclosed herein. The present invention is thus, not intended to be limited to the disclosed embodiments, rather it is to be accorded the widest scope consistent with the principles and features disclosed herein.

Details of functions and configurations well known to a person skilled in this art are omitted to make the description of the present invention clear. The same drawing reference numerals will be understood to refer to the same elements throughout the drawings.

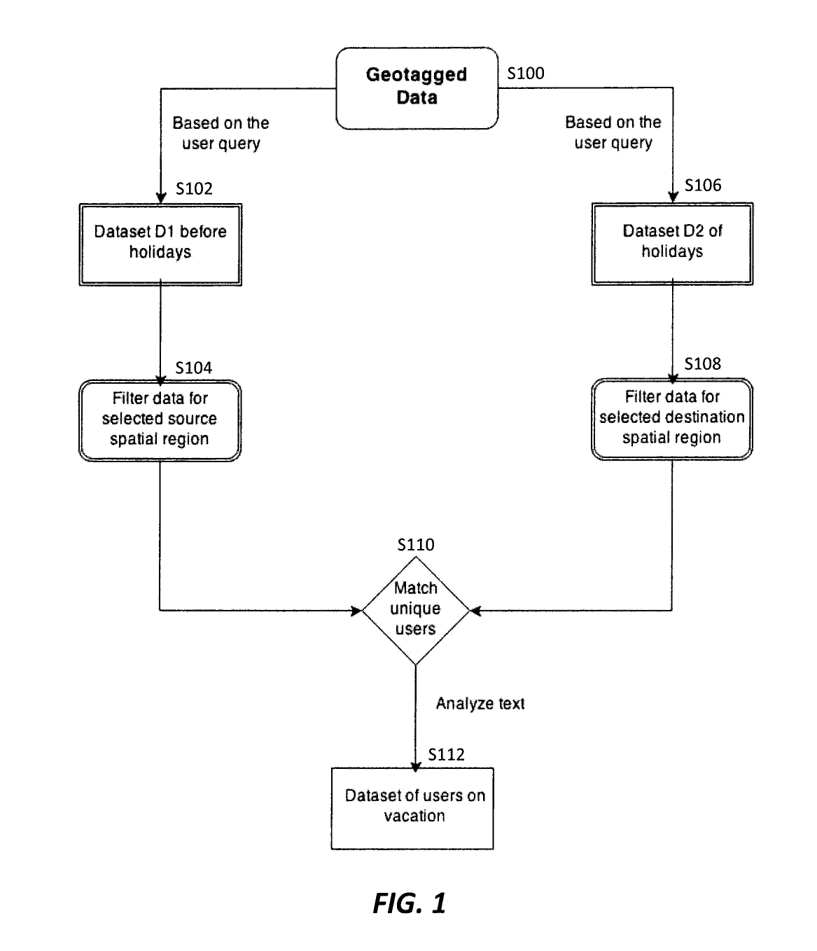

FIG. 1 shows an exemplary flow of data in an embodiment of the destination trend determination method. In this exemplary embodiment, a user query is generated based on a user (e.g., a travel planner) attempting to determine a destination trend for Saudis during spring break (e.g., a period of time starting Mar. 20, 2014 and ending Mar. 26, 2014). Analysis begins with access to geotagged data at S100 at one or more servers. The geotagged data, stored preferably in a database, contains organized information indicating at least a location (or spatial region) and a time, and is gathered from sources such as Twitter, Facebook, Flickr, and the like. For example, a portion of the database may include Twitter (microblog) posts from a plurality of users over the course of several years, the Twitter posts being time-stamped and at least a portion of the Twitter posts including location information such as a city, state, or country.

Based on the user query (i.e., destination trends for Saudis during spring break), a first dataset D1 is created from the geotagged data to include all geotagged data in the temporal period ten days before the spring break, at S102. In this example, this temporal period includes geotagged content from Mar. 10, 2014 to Mar. 19, 2014. Although ten days is used in this example, the temporal period may be longer or shorter to include more or less data in the dataset.

The first dataset D1 is the filtered for the user query's selected source spatial region, Saudi Arabia, to arrive at a filtered dataset D1 of geotagged content located in Saudi Arabia, in the temporal period of ten days before the spring break, at S104.

Also based on the user query, a second dataset D2 is created from the geotagged data to include all geotagged content in the temporal period of during the spring break, at S106. In this example, this temporal period includes geotagged data from Mar. 20, 2014 and ending Mar. 26, 2014.

The second dataset D1 is then optionally filtered for the user query's selected destination spatial region to arrive at a filtered dataset D2 of geotagged content, as S108. In this user query, which seeks to determine a destination trend for Saudis during spring break, the destination spatial region may designate a region outside Saudi Arabia or a region not-Saudi Arabia. Alternatively, a destination spatial region is not a required part of the user query. In the situation that a destination spatial region is not designated, dataset D2 is not filtered by any destination spatial region, and in this example, Saudis that remained in Saudi Arabia for spring break remain in dataset D2.

After the first dataset D1 and the second dataset D2 have been created and/or filtered, as according to the user query, the datasets are compared with each other to determine a combined dataset with unique users in both datasets, at S110. In other words, users present in both the first dataset D1 (as filtered in S104) and the second dataset D2 (optionally filtered in S108) are determined.

The content of the geotagged data is then analyzed to determine a list of users that are on vacation, at S112. The analysis may include determining that the user, in the first dataset D1, was not on vacation. For example, mundane posts from the same spatial region for all ten days may indicate that the user was not on vacation. Differences in location between the same user in the first dataset D1 and the second dataset D2 may also indicate that the user was on vacation. Furthermore, the analysis may include searching text, tags, or other metadata, performing image analysis, or the like. For example, if the geotagged content includes microblogging content (e.g., from Twitter posts), relevant analysis may include text searching for names of airports, restaurants, museums, concerts, hotels, resorts, celebrities, entertainers, parks, historical sites, other “vacation”-related terms, and the like. On the other hand, if, for example, the geotagged content includes photographic content (e.g., from Flickr posts), relevant analysis may include text searching of image tags and captions for content similar to the microblogging content discussed above, in addition to performing image recognition for well-known landmarks and locations.

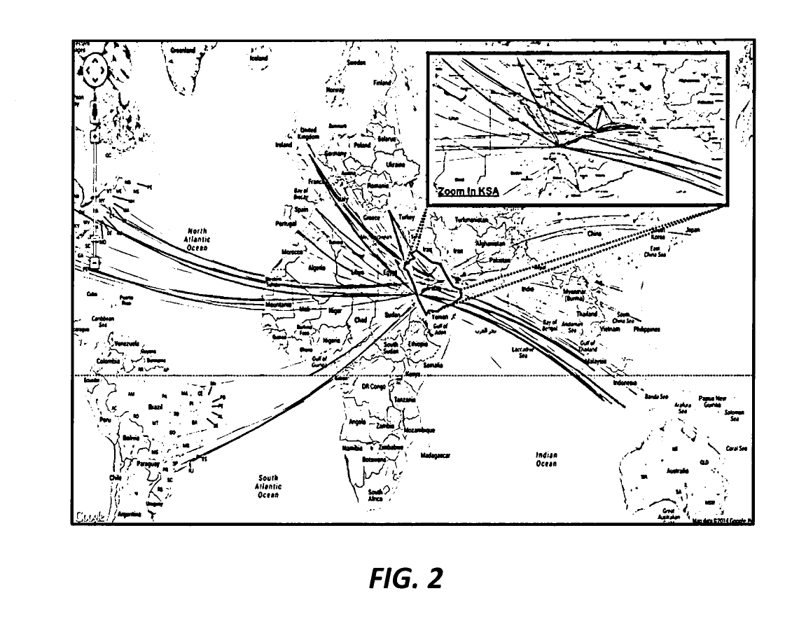

Finally, the results are prepared for presentation to the user. FIG. 2 shows an exemplary presentation of the results in the form of a map. In this example, FIG. 2 shows that many Saudis spent the spring break of 2014 in other Gulf countries, the United Kingdom, Indonesia, and Turkey. Additionally or alternatively, the results may include actual posts of the geotagged data, as well as summaries of the text for each country in the form of a tag cloud, thereby providing the user with the actual content that may be reviewed for further consideration of positive and negative traits for different locations.

As discussed earlier, a destination spatial region may also be part of the user query such that the second dataset D2 is filtered in S108. For example, a variation of the scenario described above may also include a destination spatial region of Saudi Arabia. In other words, the user query would be used to generate a first dataset D1 created from the geotagged data to include all geotagged data in the temporal period ten days before the spring break (at S102), which is then filtered for a selected source spatial region of Saudi Arabia (at S104), and a second dataset D2 created from the geotagged data to include all geotagged data in the temporal period of during the spring break (at S106), which is then filtered for the selected destination spatial region of Saudi Arabia (at S108).

As a result of this variation of the scenario, after matching and analysis in S110 and S112, a list of users that were in Saudi Arabia before spring break, and who stayed within Saudi Arabia during spring break, is determined, along with the activities and locations visited by these users during that time. The analysis may include filtering the users who were found to travel and be in at least two different cities before and during the spring break. For example, users posting from within Saudi Arabia, but from different locations before and during spring break, were found to visit the cities of Riyadh, Makkah, Madina, Jeddah, Dammam, and Abha, as well as destinations outside the cities, such as attractions in the north desert, the northeastern desert, and wildlife sanctuaries.

The examples and variations provided above are meant to be exemplary and non-limiting examples and variations of the present invention. Persons of ordinary skill may introduce further variations without departing from the spirit and scope of the present invention.

For example, the steps outlined above are not necessarily performed in the order described. The first dataset D1 and the second dataset D2 may be processed in parallel, and filtering the geotagged data for spatial regions may be performed before the temporal filtering.

As another example, the spatial regions (e.g., Saudi Arabia) and temporal period (e.g., spring break) selected are merely exemplary and any spatial regions or temporal periods may be used. A time period different from ten-days-prior may also be used to determine whether a user is on vacation or not. For example, a period of thirty days prior to spring break may be used for the dataset D1 to establish a set of users having been in, e.g., Saudi Arabia, for thirty days prior to spring break. Similarly, when filtering data for source spatial regions and destination spatial regions, it may be the case that a user is found to be have multiple locations in a short period of time (e.g., commuting between London and Paris for work, a multi-day road trip through several countries in South America, etc.). For these users, the spatial region may be selected as the final spatial region in the designated time period, the first spatial region in the designated time period, or the spatial region where the user spent the most time.

As another example, the geotagged data, which has been collected from sources including social networks, has been described to reside on one or more servers, but may also be stored locally on memory or other computer-readable medium of a user operated device. When residing on the one or more servers, the database may be easily accessed remotely by a plurality of user operated devices through a public or private network. To operate efficiently and to service a plurality of users, the database may include three main components: an indexer, a query engine, and a recovery manager. The indexer efficiently digests incoming data in light indexes, the query engine generates an optimized query plan to efficiently retrieve data from the indexes, and the recovery manager restores the database contents from backup copies in case of a memory failure.

As another example, a variety of user front ends and interfaces may be used to receive the user query and to provide the user with the data visualized results. The user query may be input by a user using any known user interface technique, including text entries, calendar widgets, cascading menus, interactive maps, and the like. Similarly, the results may be provided to the user in the form of text summaries, geotagged content, tag clouds, screenshots, interactive maps, and the like. Furthermore, known location techniques may be used to automatically populate or suggest the source and/or destination spatial regions through the user front end. For example, an IP address or GPS signal may be used to locate the user providing the user query in a particular country and fill in that information for the source spatial region.

As another example, data analysis may be customized depending on the user query. In the example provided previously, the user query included a temporal component (e.g., spring break), a source spatial region (e.g., Saudi Arabia), and optionally included a destination spatial region (e.g., Saudi Arabia). However, the temporal component may be customized to any date range or holiday or event, and any combination of source and destination spatial regions may be used. For example, a source spatial region may be indicated, or a destination spatial region may be indicated, or both a source and destination spatial region may be indicated in the user query.

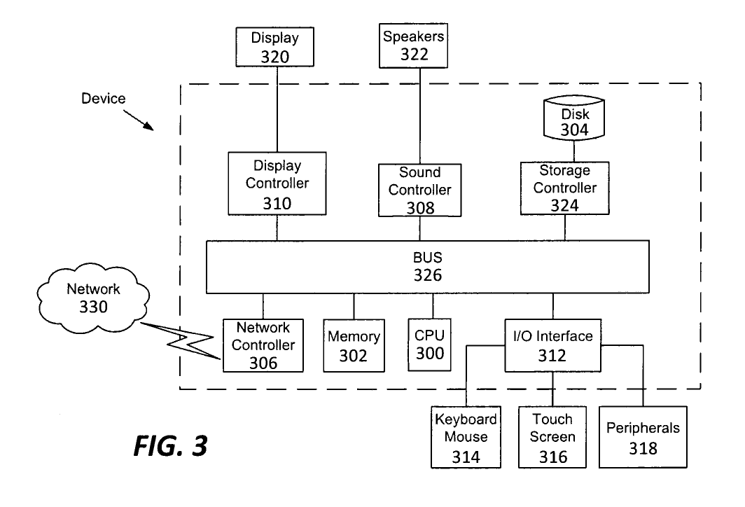

FIG. 3 is an illustration of a device used in conjunction with the above-described destination trend determination method. In FIG. 3, the device may be a smartphone, a tablet computer, a laptop computer, a desktop computer, or the like. The device includes processing circuitry, including a CPU 300, which performs the processes described above. The process data and instructions may be stored in memory 302. These processes and instructions may also be stored on a storage medium disk 304 such as a hard drive (HDD), solid state drive (SSD), or portable storage medium, or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a program, application, web interface, or component of an operating system, or combination thereof, executing in conjunction with CPU 300 and/or a remote server, and an operating system such as Android, Apple iOS, Microsoft Windows Phone, Microsoft Windows 7, UNIX, Solaris, LINUX, Apple MAC-OS, and other systems known to those skilled in the art.

The hardware elements in order to achieve the device may be realized by various circuitry elements, known to those skilled in the art. For example, CPU 300 may be a Xenon or Core processor from Intel of America, an Opteron processor from AMD of America, part of a system-on-a-chip (SoC) processor such as a Snapdragon processor from Qualcomm, or may be other processor types that would be recognized by one of ordinary skill in the art. Alternatively, the CPU 300 may be implemented on an FPGA, ASIC, PLD or using discrete logic circuits, as one of ordinary skill in the art would recognize. Further, CPU 300 may be implemented as multiple processors cooperatively working in parallel to perform the instructions of the inventive processes described above.

The device in FIG. 3 also includes a network controller 306, such as an Intel Ethernet PRO network interface card from Intel Corporation of America, for interfacing with network 330. As can be appreciated, the network 330 can be a public network, such as the Internet, or a private network such as an LAN or WAN network, or any combination thereof and can also include PSTN or ISDN sub-networks. The network 330 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The device further includes a display controller 310, such as an NVIDIA GeForce GTX or Quadro graphics adaptor from NVIDIA Corporation of America for interfacing with display 320, such as a Hewlett Packard HPL2445w LCD monitor. A general purpose I/O interface 312 interfaces with any one or a combination of input devices, such as a keyboard and/or mouse 314 or a touch screen panel 316 on or separate from display 320. General purpose I/O interface also connects to a variety of peripherals 318 including printers and scanners, such as an OfficeJet or DeskJet from Hewlett Packard.

A sound controller 308 is also provided in the device, such as Sound Blaster X-Fi Titanium from Creative, to interface with speakers/microphone 322 thereby providing sounds and/or music.

The general purpose storage controller 324 connects the storage medium disk 304 with communication bus 326, which may be an ISA, EISA, VESA, PCI, or similar, for interconnecting all of the components of the device. A description of the general features and functionality of the display 320, keyboard and/or mouse 314, as well as the display controller 310, storage controller 324, network controller 306, sound controller 308, and general purpose I/O interface 312 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset. For instance, smartphones and mobile devices benefit from system-on-a-chip (SoC) designs that integrate a plurality of circuit elements and functions.

Accordingly, a destination trend determination method and system has been described herein, which primarily provides a data driven method of finding top vacation destinations. Unlike tourism websites, which may give a list of vacation destinations to be visited all around the year, the present method determines top vacation destinations based on particular holidays by using online social network data and provides results to a user in an interactive form, including summaries, tag clouds, and maps.

Although the description and discussion are in reference to certain exemplary embodiments of the present disclosure, numerous additions, modifications and variations will be readily apparent to those skilled in the art. The scope of the invention is given by the following claims, rather than the preceding description, and all additions, modifications, variations and equivalents that fall within the range of the stated claims are intended to be embraced therein.

1: A method, comprising:
receiving a user query;
accessing, by circuitry, a database, the database including spatiotemporal content from a plurality of users;
generating, by the circuitry, a first dataset by filtering the database according to the user query;
generating, by the circuitry, a second dataset by filtering the database according to the user query;
comparing, by the circuitry, the first dataset and the second dataset to determine one or more unique users associated with spatiotemporal content in both the first dataset and the second dataset;
analyzing, by the circuitry, the spatiotemporal content of the one or more unique users to determine one or more locations of the spatiotemporal content corresponding to the second dataset; and
controlling, by the circuitry, a display of the analyzed content.

2: The method according to claim 1, wherein
the user query includes a first time period and a first location,
generating the first dataset includes filtering the database according to the first location and a second time period prior to and temporally adjacent to the first time period, and
generating the second dataset includes filtering the database according to the first time period.

3: The method according to claim 2, wherein
each unique user of the one or more unique users is associated with the first location with respect to the first dataset, and a second location with respect to the second dataset, and
the first location and the second location are different for each unique user.

4: The method according to claim 2, wherein
controlling the display of the analyzed content includes controlling a display of a map of the one or more locations of the spatiotemporal content corresponding to the second dataset of the unique users.

5: The method according to claim 2, wherein
controlling the display of the analyzed content includes controlling a display of a tag cloud of the spatiotemporal content corresponding to the second dataset of the unique users.

6: The method according to claim 1, wherein
the user query includes a first time period, a first location, and a second location,
generating the first dataset includes filtering the database according to the first location and a second time period prior to and temporally adjacent to the first time period, and
generating the second dataset includes filtering the database according to the second location and the first time period.

7: A non-transitory computer readable medium having instructions stored therein, which when executed by a computer, causes the computer to perform a method, the method comprising:
receiving a user query;
accessing a database, the database including spatiotemporal content from a plurality of users;
generating a first dataset by filtering the database according to the user query;
generating a second dataset by filtering the database according to the user query;
comparing the first dataset and the second dataset to determine one or more unique users associated with spatiotemporal content in both the first dataset and the second dataset;
analyzing the spatiotemporal content of the one or more unique users to determine one or more locations of the spatiotemporal content corresponding to the second dataset; and
controlling a display of the analyzed content.

8: The non-transitory computer readable medium according to claim 7, wherein
the user query includes a first time period and a first location,
generating the first dataset includes filtering the database according to the first location and a second time period prior to and temporally adjacent to the first time period, and
generating the second dataset includes filtering the database according to the first time period.

9: The non-transitory computer readable medium according to claim 8, wherein
each unique user of the one or more unique users is associated with the first location with respect to the first dataset, and a second location with respect to the second dataset, and
the first location and the second location are different for each unique user.

10: The non-transitory computer readable medium according to claim 8, wherein
controlling the display of the analyzed content includes controlling a display of a map of the one or more locations of the spatiotemporal content corresponding to the second dataset of the unique users.

11: The non-transitory computer readable medium according to claim 8, wherein
controlling the display of the analyzed content includes controlling a display of a tag cloud of the spatiotemporal content corresponding to the second dataset of the unique users.

12: The non-transitory computer readable medium according to claim 7, wherein
the user query includes a first time period, a first location, and a second location,
generating the first dataset includes filtering the database according to the first location and a second time period prior to and temporally adjacent to the first time period, and
generating the second dataset includes filtering the database according to the second location and the first time period.

13: An apparatus, comprising:
circuitry configured to
receive a user query;
access a database, the database including spatiotemporal content from a plurality of users;
generate a first dataset by filtering the database according to the user query;
generate a second dataset by filtering the database according to the user query;
compare the first dataset and the second dataset to determine one or more unique users associated with spatiotemporal content in both the first dataset and the second dataset;
analyze the spatiotemporal content of the one or more unique users to determine one or more locations of the spatiotemporal content corresponding to the second dataset; and
control a display of the analyzed content.

14: The apparatus according to claim 13, wherein
the user query includes a first time period and a first location,
generating the first dataset includes filtering the database according to the first location and a second time period prior to and temporally adjacent to the first time period, and
generating the second dataset includes filtering the database according to the first time period.

15: The apparatus according to claim 14, wherein
each unique user of the one or more unique users is associated with the first location with respect to the first dataset, and a second location with respect to the second dataset, and
the first location and the second location are different for each unique user.

16: The apparatus according to claim 14, wherein
controlling the display of the analyzed content includes controlling a display of a map of the one or more locations of the spatiotemporal content corresponding to the second dataset of the unique users.

17: The apparatus according to claim 14, wherein
controlling the display of the analyzed content includes controlling a display of a tag cloud of the spatiotemporal content corresponding to the second dataset of the unique users.

18: The apparatus according to claim 13, wherein
the user query includes a first time period, a first location, and a second location,
generating the first dataset includes filtering the database according to the first location and a second time period prior to and temporally adjacent to the first time period, and
generating the second dataset includes filtering the database according to the second location and the first time period.
